(19) United States
(12) Patent Application Publication
(10) Pub. No.: US 2014/0090780 A1
(43) Pub. Date: Apr. 3, 2014

(54) SEALING METHOD AND DEVICE OF POUCH TYPE SECONDARY BATTERY

(71) Applicant: Byoung Cheon Jeong, Daejeon (KR)

(72) Inventor: Byoung Cheon Jeong, Daejeon (KR)

(73) Assignee: SK INNOVATION CO., LTD., Seoul (KR)

(21) Appl. No.: 14/114,795

(22) PCT Filed: May 10, 2012
(86) PCT No.: PCT/KR2012/003673

§ 371 Date: Oct. 30, 2013

(30) Foreign Application Priority Data
May 13, 2011 (KR) 10-2011-0045084

(51) Int. Cl. H01M 2/02

(52) U.S. Cl. CPC H01M 2/0212
USPC 156/274.4; 156/379.6

(57) ABSTRACT

Provided are a sealing method and device of a pouch type secondary battery including a pouch and an electrode tab provided for electrical connection with the pouch, in which the electrode tab is heated so that heat may be supplied to a tab sealant bonding between a bonding surface of a sealing part of the pouch and the electrode tab at the time of sealing the pouch type secondary battery.

### TECHNICAL FIELD

The present invention relates to a sealing method and device of a pouch type secondary battery, and more particularly, to a sealing method and device of a pouch type secondary battery including a pouch and an electrode tab provided for electrical connection with the pouch, in which the electrode tab is heated so that heat may be supplied to a tab sealant bonding between a bonding surface of a sealing part of the pouch and the electrode tab at the time of sealing the pouch type secondary battery.

### BACKGROUND ART

Generally, research into a secondary battery capable of being charged and discharged unlike a primary battery has been actively conducted in accordance with the development of state-of-the-art fields such as a digital camera, a cellular phone, a laptop computer, a hybrid automobile, and the like. An example of the secondary battery includes a nickel-cadmium battery, a nickel-metal hydride battery, a nickel-hydrogen battery, and a lithium secondary battery. Among them, the lithium secondary battery is used as a power supply of a portable electronic device or a plurality of lithium secondary batteries are connected in series with each other to thereby be used for a high output hybrid automobile. Since this lithium secondary battery has operating voltage three times higher than that of the nickel-cadmium battery or the nickel-metal hydride battery and is more excellent in view of energy density characteristics per unit weight than the nickel-cadmium battery or the nickel-metal hydride battery, the use of the lithium secondary battery has rapidly increased.

The lithium secondary battery as described above may be manufactured in various types. As a typical type of the lithium secondary battery, there are a cylindrical type and a prismatic type that are mainly used for a lithium ion battery. A lithium polymer battery that has been recently spotlighted is manufactured in a pouch type having flexibility. The pouch type lithium polymer battery as described above (hereinafter, referred to as a “pouch type secondary battery”) is a comparatively free in a shape thereof.

FIG. 1 is a sealing method and a side view of device 20 of a general pouch type secondary battery 10.

Referring to FIG. 1, the general pouch type secondary battery 10 is configured to include a pouch 1 and an electrode tab 2 provided for electrical connection with the pouch 1. The pouch 1 is injected with an electrolyte in a state in which it is opened, and the electrode tab 2 is formed with a sealing part 3 sealed so that the pouch 1 is closed in a state in which it is extended from an electrode in the pouch 1 so as to be protruded outwardly of the pouch 1. In this configuration, a pouch sealant 4 (that is a material capable of bonding at least two surfaces to each other and serving as a barrier or a protective coating) is coated on a bonding surface of the sealing part 3, and a tab sealant 5 is coated on a bonding surface of the electrode tab 2. A sealing device 20 melting the pouch sealant 4 and the tab sealant 5 to close the pouch 1 is a sealing bar applying predetermined heat and pressure to both sides of the sealing part 3 for a predetermined time.

The pouch sealant 4 and the tab sealant 5 as described above may be the same closing material that may be polypropylene having a melting temperature of 139 to 143° C. However, as current capacity of the pouch type secondary battery 10 increases, even though set conditions of pressure and a time are raised while a set temperature of the sealing device 20 is maintained at a temperature higher than 143° C., it is not easy to satisfy a sealing condition under which the electrolyte of the pouch type secondary battery 10 is not leaked. The reason is that as the current capacity of the pouch type secondary battery 10 increases, a size of the pouch 1 increases, such that the heat applied to the sealing part 3 by the sealing device 20 is taken away by the electrode in the pouch 1 before the heat melts the tab sealant 5.

As described above, as the current capacity of the pouch type secondary battery 10 increases, the size of the pouch 1 increases, and the heat applied to the sealing part 3 by the sealing bar 20 in order to melt the tab sealant 5 is taken away by the electrode in the pouch 1, such that it is not easy to satisfy the sealing condition of the pouch type secondary battery 10. In addition, as the set conditions of the pressure and the time of the sealing bar 30 for sealing the sealing part 3 increases, a facility cost and a sealing process time increase.

### DISCLOSURE OF INVENTION

### Technical Problem

An object of the present invention is to provide a sealing method and device of a pouch type secondary battery including a pouch and an electrode tab provided for electrical connection with the pouch, in which the electrode tab is heated so that heat may be supplied to a tab sealant bonding between a bonding surface of a sealing part of the pouch and the electrode tab at the time of sealing the pouch type secondary battery.

### Solution to Problem

In one general aspect, a sealing method of a pouch type secondary battery including a pouch, an electrode tab extended from an electrode in the pouch so as to be protruded outwardly of the pouch for electrical connection, and a sealing part sealed so that the pouch is closed after an electrolyte is injected into the pouch, includes: heating the electrode tab so that heat is supplied to a tab sealant bonding between a bonding surface of the sealing part and the electrode tab; and sealing the sealing part.

In another general aspect, a sealing device of a pouch type secondary battery including a pouch, an electrode tab extended from an electrode in the pouch so as to be protruded outwardly of the pouch for electrical connection, and a sealing part sealed so that the pouch is closed after an electrolyte is injected into the pouch, includes: a pair of sealing bars closely adhered to both sides of the sealing part to heat and press the sealing part; and a pair of heating bars closely adhered to both sides of the electrode tab to heat the electrode tab.

A temperature at which the sealing bar heats the sealing part may be 185 to 195° C.

A temperature at which the heating bar heats the electrode tab may be 185 to 195° C.

### Advantageous Effects of Invention

With the sealing method and device of the pouch type secondary battery according to the exemplary embodiments of the present invention, the electrode tab is heated so that the heat is supplied to the tab sealant bonding between the bonding surface of the sealing part and the electrode tab and the sealing part is then sealed to allow the heat supplied to the sealing part in order to melt the tab sealant so as not to be taken away by the electrode in the pouch, such that the pressure and the time at which the pouch type secondary battery is sealed are minimized, thereby making it possible to reduce the facility cost and the sealing process time.

### BRIEF DESCRIPTION OF DRAWINGS

The above and other objects, features and advantages of the present invention will become apparent from the following description of preferred embodiments given in conjunction with the accompanying drawings, in which:

FIG. 1 is a side view of a sealing method and device of a general pouch type secondary battery.

FIG. 2 is a side view of a sealing method and device of a pouch type secondary battery according to an exemplary embodiment of the present invention.

FIG. 3 is a perspective view of the pouch type secondary battery of FIG. 2.

FIG. 4 is a front view of FIG. 3.

FIG. 5 is a table showing sealing results according to sealing conditions and current capacity of the pouch type secondary battery.

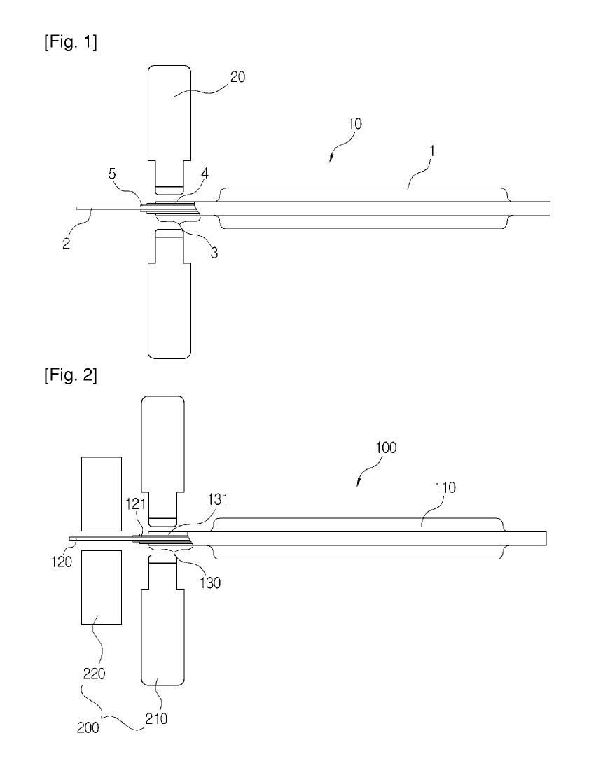

### DETAILED DESCRIPTION OF MAIN ELEMENTS

100: pouch type secondary battery

110: pouch

120: electrode tab 121: tab sealant

130: sealing part 131: pouch sealant

200: sealing device

210: sealing bar

220: heating bar

### BEST MODE FOR CARRYING OUT THE INVENTION

Hereinafter, a technical spirit of the present invention will be described in more detail with reference to the accompanying drawings.

However, the accompanying drawings are only examples shown in order to describe the technical idea of the present invention in more detail. Therefore, the technical idea of the present invention is not limited to shapes of the accompanying drawings.

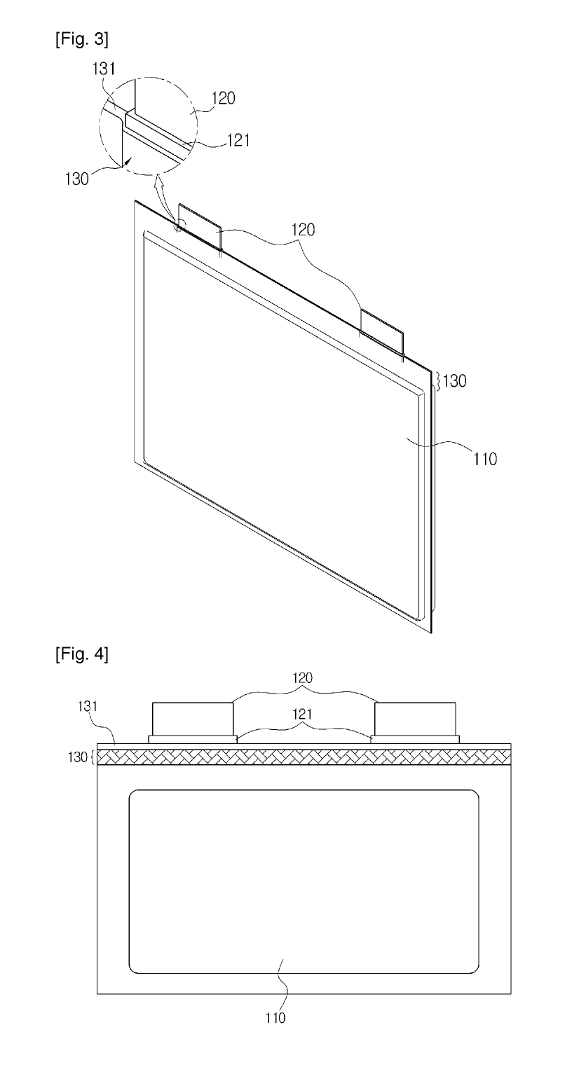

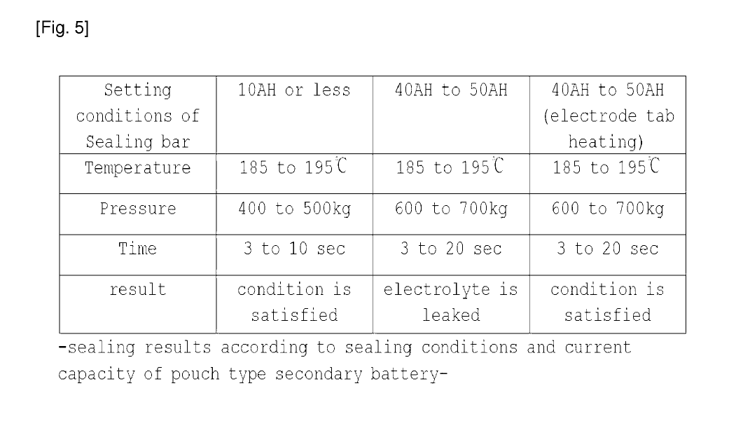

FIG. 2 is a side view of a sealing method and device 200 of a pouch type secondary battery 100 according to an exemplary embodiment of the present invention; FIG. 3 is a perspective view of the pouch type secondary battery 100 of FIG. 2; FIG. 4 is a front view of FIG. 3; and FIG. 5 is a table showing sealing results according to sealing conditions and current capacity of the pouch type secondary battery 100.

The present invention relates to a sealing method and device 200 of a pouch type secondary battery 100, and more particularly, to a sealing method and device 200 of a pouch type secondary battery 100 including a pouch 110 and an electrode tab 120 provided for electrical connection with the pouch 110, in which the electrode tab 120 is heated so that heat may be supplied to a tab sealant 121 bonding between a bonding surface of a sealing part 130 of the pouch 110 and the electrode tab 120 at the time of sealing the pouch type secondary battery 100.

Referring to FIGS. 2 to 4, the sealing method of the pouch type secondary battery 100 according to the exemplary embodiment of the present invention is a sealing method of the pouch type secondary battery 100 configured to include the pouch 110, the electrode tab 120 extended from an electrode in the pouch 110 so as to be protruded outwardly of the pouch 110 for electrical connection, and the sealing part 130 sealed so that the pouch 110 is closed after an electrolyte is injected into the pouch 110. In the sealing method as described above, a pouch sealant 131 is coated on the bonding surface of the sealing part 130, a tab sealant 121 is coated on a bonding surface of the electrode tab 120, predetermined heat and pressure are applied to both sides of the sealing part 130 for a predetermined time, and the heat applied to the sealing part 130 melts the pouch sealant 131 and the tab sealant 121 to bond the sealing part 130 and the bonding surface of the electrode tab 120, thereby making it possible to close the pouch 110. However, in the case of this pouch type secondary battery 100, as current capacity increases, a size of the pouch 110 increases, such that the heat applied to the sealing part 130 at the time of sealing may be taken away by the electrode in the pouch 110 before it melts the tab sealant 121. Here, since a temperature at which the sealing part 130 of the pouch 110 is sealed needs to be a temperature in a range in which the pouch sealant 131 and the tab sealant 121 may be melted in a short time and the pouch 110 is not damaged, a temperature of the heat among conditions under which the sealing part 130 is sealed may be a dependent condition in which it is maintained without a change even though the current capacity of the pouch type secondary battery 100 is changed. In addition, even though pressure and time conditions under which the sealing part 130 is sealed are raised, it is not easy to satisfy a sealing condition under which the electrolyte injected into the pouch 110 is not leaked, and when the pressure and time conditions under which the sealing part 130 is sealed are raised, the facility cost and the sealing process time increase. Therefore, after the electrode tab 120 is heated so that the heat is supplied to the tab sealant 121 bonding between the bonding surface of the sealing part 130 and the electrode tab 120, the sealing part 130 is sealed. In the above-mentioned structure, even though the size of the pouch 110 increases as the current capacity of the pouch type secondary battery 100 increases, since the pressure and the time at which the sealing part 130 is sealed may be minimized, the facility cost and the sealing process time may be reduced.

Referring to FIGS. 2 to 4, the sealing device 200 of the pouch type secondary battery 100 according to the exemplary embodiment of the present invention is a sealing device 200 of the pouch type secondary battery 100 configured to include the pouch 110, the electrode tab 120 extended from an electrode in the pouch 110 so as to be protruded outwardly of the pouch 110 for electrical connection, and the sealing part 130 sealed so that the pouch 110 is closed after an electrolyte is injected into the pouch 110. The sealing device 200 as described above includes a pair of sealing bars 210 closely adhered to both sides of the sealing part 130 to heat and press the sealing part 130 and a pair of heating bars 220 closely adhered to both sides of the electrode tab 120 to heat the electrode tab 120. The sealing bar 210 as described above has set conditions of a temperature, pressure, and a time and applies heat having the set temperature and the set pressure to the sealing part 130 by the set time, and the pouch sealant 131 between the bonding surface of each side of the sealing part 130 and the tab sealant 121 between the bonding surface of the sealing part 130 and the electrode tab 120 are melted to bond the sealing part 130, thereby making it possible to close the pouch 110. However, in the case of this pouch type secondary battery 100, as current capacity increases, a size of the pouch 110 increases, such that the heat applied to the sealing part 130 at the time of sealing may be taken away by the electrode in the pouch 110 before it melts the tab sealant 121. Here, since the set temperature of the sealing bar 210 needs to be a temperature in a range in which the pouch sealant 131 and the tab sealant 121 may be melted in a short time and the pouch 110 is not damaged, the set temperature among the set conditions of the sealing bar 210 may be a dependent condition in which it is maintained without a change even though the current capacity of the pouch type secondary battery 100 is changed. In addition, even though the set pressure and the set time of the sealing bar 210 are raised, it is not easy to satisfy the sealing condition under which the electrolyte injected into the pouch 110 is not leaked, and when the set pressure and the set time of the sealing bar 210 are raised, a sealing process time and a facility cost increase. Therefore, the sealing device 200 includes the pair of sealing bars 210 closely adhered to both sides of the sealing part 130 to apply heat and pressure to the sealing part 130 and the pair of heating bars 220 closely adhered to both sides of the electrode tab 120 to heat the electrode tab 120, such that the heating bars 220 heat the electrode tab 120 extended from the electrode in the pouch 110 and the sealing bars 210 then seal the sealing part 130 so as to prevent a phenomenon that the heat applied to the sealing part 130 by the sealing parts 210 does not melt the tab sealant 121, but is taken away by the electrode in the pouch 110. In the above-mentioned structure, even though the size of the pouch 110 increases as the current capacity of the pouch type secondary battery 100 increases, since the set pressure and the set time of the sealing bar 210 may be minimized, the facility cost and the sealing process time may be reduced.

Here, the pouch type secondary battery 100 includes an electrode tab 120 having a cathode and an electrode tab 120 having an anode. As shown in FIGS. 2 to 4, the electrode tab 120 having the cathode and the electrode tab 120 having the anode may be protrudedly formed at one side of the pouch 110 so as to be spaced apart from each other. Alternatively, although not shown, the electrode tab 120 having the cathode may be formed at one side of the pouch 100 and the electrode tab 120 having the anode may be formed at the other side thereof.

In addition, the temperature at which the sealing bar 210 as described above heats the sealing part 130 may be 185 to 195° C. The pouch sealant 131 and the tab sealant 121 as described above may be the same closing material that may be polypropylene having a melting temperature of 139 to 143° C. In addition, as the pouch 110 of the pouch type secondary battery 100, an aluminum pouch may be used. In this case, a use temperature of the aluminum pouch is 200° C. or less. In addition, the sealing bar 210 may be controlled so as to be turned on/off in order to maintain the set temperature. That is, when a temperature of the sealing bar 210 is lowered by a predetermined temperature or more based on the set temperature of the sealing bar 210, the sealing bar 210 is turned on, and when it is raised by a predetermined temperature based on the set temperature of the sealing bar 210, the sealing bar 210 is turned off. Here, a difference between the temperatures at which the sealing bar 210 is turned on/off based on the set temperature of the sealing bar 210 is called hunting. Therefore, the temperature at which the sealing bar 210 seals the sealing part 130 may be 185 to 195° C. so as to melt the pouch sealant 131 and the tab sealant 121 in a short time while preventing the damage of the pouch 110 in consideration of the temperature hunting of the sealing bar 210.

In addition, the temperature at which the heating bar 220 as described above heats the electrode tab 120 may be 185 to 195° C. In order to allow the tab sealant 121 not to be taken away by the electrode tab 120, the set temperatures of the heating bar 220 heating the electrode tab 120 and the sealing bar 210 heating the sealing part 130 need to be the same as each other. In addition, the temperature of the sealing bar 210 may be set to a temperature of 185 to 195° C. at which the pouch sealant 131 and the tab sealant 121 may be melted in a short time and the damage of the pouch 110 may be prevented in consideration of the temperature hunting of the sealing bar 210 in a maximum use temperature of the pouch 110 formed of an aluminum pouch. Therefore, the set temperature of the heating bar 220 may also be 185 to 195° C.

Referring to FIG. 5, in the case in which the pouch type secondary battery 100 is manufactured to have current capacity of 10 AH or less, the sealing part 130 is sealed without heating the electrode tab 120, and conditions of the sealing bar 210 are set as follows: a temperature of 185 to 195° C., pressure of 400 to 500 kg, and a time of 3 to 10 seconds, the sealing condition under which the electrolyte injected into the pouch 110 is not leaked is satisfied; however, in the case in which the pouch type secondary battery 100 is manufactured to have current capacity of 40 to 50 AH larger than the current capacity of 10 AH, the sealing part 130 is sealed without heating the electrode tab 120, and conditions of the sealing bar 210 are set as follows: a temperature of 185 to 195° C., pressure of 600 to 700 kg, and a time of 3 to 20 seconds, the sealing condition under which the electrolyte injected into the pouch 110 is not leaked is not satisfied. Further, in the case in which the pouch type secondary battery 100 is manufactured to have current capacity of 40 to 50 AH, the sealing part 130 is sealed after heating the electrode tab 120, and conditions of the sealing bar 210 are set as follows: a temperature of 185 to 195° C., pressure of 600 to 700 kg, and a time of 3 to 10 seconds, the sealing condition under which the electrolyte injected into the pouch 110 is not leaked is satisfied. Since the pressure and the time at which the pouch type secondary battery 100 is sealed may be minimized when the sealing method and device 200 heating the electrode tab 120 at the time of sealing the pouch type secondary battery 100 as described above is used, it may be advantageous in view of a facility cost and productivity to use the above-mentioned sealing method and device 200.

In the sealing method and device 200 of the pouch type secondary battery 100 as described above, the heat is applied to the electrode tab 120 so that the heat is supplied to the tab sealant 121 filled in the space between the bonding surface of the sealing part 130 and the electrode tab 120 and the sealing part 130 is then sealed to allow the heat supplied to the sealing part 130 in order to melt the tab sealant 121 not to be taken away by the electrode tab 120, such that the pressure and the time at which the pouch type secondary battery 100 is sealed are minimized, thereby making it possible to reduce the facility cost and the sealing process time.

The present invention is not limited to the above-mentioned exemplary embodiments, and may be variously applied, and may be variously modified without departing from the gist of the present invention claimed in the claims.

1. A sealing method of a pouch type secondary battery including a pouch, an electrode tab extended from an electrode in the pouch so as to be protruded outwardly of the pouch for electrical connection, and a sealing part sealed so that the pouch is closed after an electrolyte is injected into the pouch, comprising:
heating the electrode tab so that heat is supplied to a tab sealant
bonding between a bonding surface of an inner side of the sealing part and the electrode tab; and
sealing the sealing part.

2. A sealing device of a pouch type secondary battery including a pouch, an electrode tab extended from an electrode in the pouch so as to be protruded outwardly of the pouch for electrical connection, and a sealing part sealed so that the pouch is closed after an electrolyte is injected into the pouch, comprising:
a pair of sealing bars closely adhered to both sides of the sealing part to heat and press the sealing part; and
a pair of heating bars closely adhered to both sides of the electrode tab to heat the electrode tab.

3. The sealing device of claim 2, wherein a temperature at which the sealing bar heats the sealing part is 185 to 195° C.

4. The sealing device of claim 2, wherein a temperature at which the heating bar heats the electrode tab is 185 to 195° C.
